(19) United States
(12) Patent Application Publication
(10) Pub. No.: US 2013/0148947 A1
(43) Pub. Date: Jun. 13, 2013

(54) VIDEO PLAYER WITH MULTIPLE GRPAHICS PROCESSORS

(71) Applicant: ATI Technologies ULC, Markham (CA)

(72) Inventors: David I.J. Glen, Toronto (CA); Philip J. Rogers, Pepperell, MA (US); Jeffrey Cheng, Toronto (CA); Wai Lo, Richmond Hill (CA); Daniel Wong, Cupertino, CA (US); Kenneth Man, Richmond Hill (CA)

(73) Assignee: ATI TECHNOLOGIES ULC, Markham (CA)

(21) Appl. No.: 13/713,403

(22) Filed: Dec. 13, 2012

Related U.S. Application Data
(60) Provisional application No. 61/569,968, filed on Dec. 13, 2011.

(51) Int. Cl. H04N 5/917

(52) U.S. Cl. CPC H04N 5/917
USPC 386/355

(57) ABSTRACT

A device and method for playing digital video are disclosed. The device includes multiple graphics processing units. The method involves using the multiple graphics processors to decode and output compressed audiovisual stream to a display and a speaker. Audiovisual bit streams possibly containing multi-stream video are efficiently decoded and displayed by sharing decoding-related tasks among multiple graphical processing units.

### RELATED APPLICATIONS

This application claims priority to Provisional Application Ser. No. 61/569,968, filed on Dec. 13, 2011, having inventors David Glen et al., titled “VIDEO PLAYER WITH MULTIPLE GRAPHICS PROCESSORS”, and is incorporated herein by reference.

### FIELD OF THE INVENTION

The present invention relates generally to digital video players, and more particularly to efficient utilization of graphics processors in digital video players.

### BACKGROUND OF THE INVENTION

Digital video has become widely available to consumers and businesses. Standardized digital video distribution formats and associated digital video players have helped to make digital video commonplace. In particular, DVD, Blu-ray Discs and digital video downloading have become popular media for digital content distribution along with players and a wide array of media content targeted for DVD distribution.

The success of DVD has been due in part to its ability to distribute large amounts of recorded digital data and its relatively low cost. In addition to video content, DVDs are also often used to distribute other digital content such as software, electronic documentation, digital music and the like. As such DVD drives are among the most common peripherals in a typical modern PC.

Although DVD provides improved video playback features including menus and optional subtitles which were not available in older analog technologies such as VHS (video home system), the resolution of digital video stored on DVDs is standard definition (SD). Lately however, newer formats such as Blu-ray, which encode video in high definition (HD) resolution, have become increasingly popular. HD resolutions can be as high as 1920×1080 pixels.

The standards and technologies behind Blu-ray allow for a much larger capacity disc than DVD, which enables the encoding of substantially more data onto a medium (i.e., Blu-ray disc). In addition, other beneficial features that enhance the user experience including surround sound audio, picture-in-picture (PIP) video and higher quality video compression algorithms such as the H.264 or the VC-1 standard are available in Blu-ray.

Unfortunately however, these enhancements add substantially to the computational load of data processing subsystems in video player devices that decode video content encoded using these formats. Accordingly newer video players require more powerful computing resources. This, in turn, often entails the use of newer graphics processing engines with a much larger number of transistors, and consequently an increase in power consumption commensurate with the increased number of transistors. Not surprisingly, this adds to the cost of video players.

In some computing devices, a built-in integrated graphics processor (IGP) may already be provided. However, as many existing IGPs may not be capable of decoding HD content, a more powerful graphics processing unit (GPU) is often added to such computing devices by way of a graphics expansion card to enable decoding of Blu-ray distributed motion video. This often makes an existing IGP superfluous.

Furthermore, a powerful GPU often consumes power at consumption levels that may be too high for its practical use in a mobile computing device such as a laptop. Such a powerful graphics card, incorporated into video players may include multiple graphics processing units and other processing blocks which consume more power. As a result, it is sometimes necessary to exclude advanced graphics capabilities from graphics cards intended for use in mobile, battery operated video players.

Accordingly, there remains a need to conserve power and efficiently utilize available computing resources in computing devices that are used as high definition digital video players.

### SUMMARY OF EMBODIMENTS OF THE INVENTION

In accordance with an aspect of the present invention, there is provided a method of operating a video device comprising an input for receiving a plurality of compressed streams corresponding to different image layers, a processing engine comprising a first graphics processing unit (GPU), a second GPU, memory interconnected to at least one of said first GPU and second GPU and a display output interface. The method comprises: (i) reading and decoding plurality of compressed streams via the input using the first GPU to form a plurality of source images to be composited; (ii) compositing in the memory, corresponding ones of the source images using the second GPU, to form display images; and (iii) outputting the display images by way of the display output interface.

In accordance with another aspect of the present invention, there is provided a method of operating a video device. The device comprises: an input for receiving a plurality of compressed video streams corresponding to different image layers, a processing engine comprising: a first graphics processing unit (GPU), a second GPU, memory and a display output interface each interconnected to at least one of the first GPU and second GPU, the method comprising: (i) reading and decoding the plurality of compressed video streams via the input to form a plurality of source images to be composited, using the first GPU; (ii) compositing in the memory, corresponding ones of the source images to form a display image, using the first GPU; and (iii) outputting the display images to an interconnected display through the display output interface, using the second GPU.

In accordance with yet another aspect of the present invention, there is provided a method of operating a computing device comprising: an input for receiving a plurality of compressed video streams corresponding to different image layers, a processing engine comprising: a first graphics processing unit (GPU), a second GPU, a processor, memory and a display output interface each interconnected to at least one of the first and second GPUs. The method comprises: (i) reading and decoding a first one of the plurality of streams to form a plurality of video frames, using the first GPU; (ii) reading and decoding a second one of the plurality of streams to form graphics segments, using the first GPU; (iii) compositing the graphics segments to form a plurality of overlay images, using the first GPU; (iv) compositing in the memory, corresponding ones of the video frames and the overlay images using the first GPU, to form a plurality of display images; (v)compositing the display images with user interface elements of a video application to form a video application window for display using one of the first and second GPUs; and (vi) compositing the video application window with other application windows and a background desktop image, to form an output screen for display on a display interconnected to the display interface.

In accordance with yet another aspect of the present invention, there is provided a digital video player device comprising: (i) an input for receiving a plurality of streams, each corresponding to one of a plurality of image layers; (ii) a graphics processing engine comprising a first graphics processing unit (GPU) and a second GPU; (iii) memory in communication with the first and second GPUs; and (iv) a display output interface. The input receives the streams; the graphics processing engine processes the streams to from images corresponding to the plurality of image layers using the first GPU and compositing in the memory, corresponding ones of the images from display images, the second GPU outputting the display images to an interconnected display through the display output interface.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a block diagram of a conventional video player device in the form of a personal computer;

FIG. 2 is a block diagram of a personal computer adapted to function as a video player device exemplary of an embodiment of the present invention;

FIG. 3 is a flowchart depicting major steps involved in presenting a multi-layered image constructed from multiple streams using an exemplary computing device;

FIG. 4 is a simplified block diagram of video decoding and processing stages typically performed by a video player device exemplary of an embodiment of the present invention;

FIG. 5 is a further simplified block diagram of video decoding and audio decoding stages performed by a video player device exemplary of an embodiment of the present invention; and

FIG. 6 is a block diagram of another embodiment video player device exemplary of another embodiment of the present invention.

### DETAILED DESCRIPTION

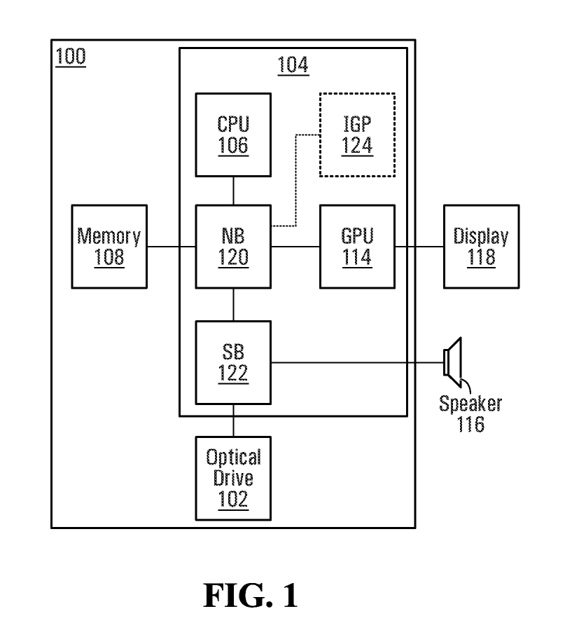

FIG. 1 illustrates a simplified block diagram of a conventional video player device 100 in the form of a computer. Device 100 includes an optical drive 102, a processing engine 104, and memory 108. Processing engine 104 interconnects optical drive 102.

Processing engine 104 may contain a graphics processing unit (GPU) 114, a general purpose processor 106, a memory interface circuit 120 (sometimes called the “North Bridge”), and input-output (I/O) interface circuit 122 (sometimes called the “South Bridge”). A speaker 116 interconnected to processing engine 104 is used to output audio encoded onto a medium such as an optical disc after decompression by processing engine 104. A display 118, interconnected to processing engine 104, is used to display images and video decoded by device 100.

Device 100 may be a dedicated video player (e.g., a Blu-ray player) capable of decoding and displaying encoded digital video distributed using a medium; or a computing device such as a personal computer (PC) or a laptop computer, equipped with an optical drive. A bus, such as the serial advanced technology attachment (SATA) bus or a similar suitable bus may be used interconnect drive 102 with processing engine 104. Processor 106 may be a central processing unit (CPU) with an AMD x86 based architecture. GPU 114 may be part of a Peripheral Component Interconnect Express (PCIe) graphics card. Memory 108 may be shared by processor 106 and GPU 114 using memory interface circuit 120. Alternately, GPU 114 may have its own local memory.

In operation, a suitable medium such as an optical disc containing audiovisual content that may include multiple image layers (e.g., Blu-ray disc), may be loaded into drive 102. Device 100 reads encoded data from the disc placed in drive 102 and decodes, composites decoded frames and/or images, and renders final images. Device 100 may also decode and output audio content onto speaker 116.

The final image output by device 100 may be the result of compositing many source images corresponding to individual image layers. In Blu-ray, for example, multiple streams corresponding to primary video, secondary video, background, presentation graphics and interactive graphics may be present. The source images to be composited typically have a composition order so that a background image is placed behind a foreground image when compositing to form an output image. Compositing may of course involve more than two source images.

Blu-ray discs contain encoded streams can be decoded, and composited for presentation. For example the secondary video may be a picture-in-picture (PIP) video, and frames from the secondary video are displayed inside corresponding frames from the primary video.

Typically, both the primary and secondary video streams may be compressed streams. Compressed video streams may, for example, be received in the form of a multiplexed sequence of packets known as packetized elementary stream (PES). The compression may utilize MPEG-2, H.264, VC-1 or similar compression standard. In addition, other streams containing images to be composited may be present. For example, in Blu-ray, there are two graphics streams (the interactive graphics stream and the presentation graphics stream) that are decoded into graphics images and composited with frames from the primary and secondary streams. Graphics images may be used to display subtitles, menus and the like.

A video stream, as used herein, refers to a data stream that may be decoded or interpreted to form a series of moving images that are to be presented in a sequence. Moving images in a video stream may represent an image plane. Image plane can be overlaid or composited to form images ultimately presented to a viewer. Example video streams include MPEG elementary streams, Bluray presentation graphics and interactive graphics streams, Bluray primary and secondary video streams (e.g. VC-1, H.264, MPEG-2), text subtitle streams. Other video streams will be apparent to those of ordinary skill.

Displaying multi-stream video increases the computational load on player device 100 as each stream needs to be decoded into frames by processing engine 104 and compositing of corresponding frames is required before presentation. The composited image may then be displayed on display 118 using a display interface such as a HDMI, DVI, DisplayPort, VGA or analog TV output interface, or a suitable wireless display interface (e.g. WiDi).

Processing each video stream may consume an appreciable amount of power. Each image plays may have full HD resolution (1920×1080 pixels). In addition, there may be digital components in device 100, such as an integrated graphics processor (IGP) 124 that may not be utilized as they may lack the capability to decode HD video. However, although not used, an IGP may nonetheless consume appreciable amounts of static power. As will be appreciated by those skilled in the art, in some integrated circuit process technologies, static power consumption rivals dynamic power consumption.

Thus, in embodiments exemplary of the present invention, an improved player device and method of operation may be used to decode digital video efficiently, utilizing available computing resources while also limiting power consumption. Notably, each of the video streams in multi-stream video inputs may be decoded and/or processed independently and thus concurrently. In addition, decoding and outputting audio to an interconnected speaker may also be performed independently of the video frames.

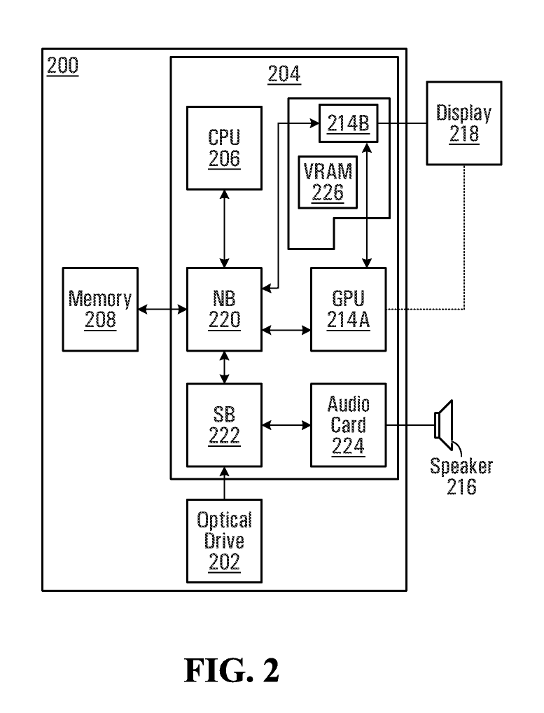

Accordingly, FIG. 2 depicts a simplified block diagram of a video player device 200 exemplary of an embodiment of the present invention. Device 200 includes an optical drive 202, a processing engine 204, and a block of memory 208. Player device 200 may be interconnected to a display 218 using a display output interface such as the digital visual interface (DVI) or the high-definition multimedia interface (HDMI). Optical drive 202 and processing engine 204 may be interconnected using SATA bus.

Processing engine 204 may contain multiple graphics processing units (GPUs) 214A, 214B (individually and collectively GPUs 214), a general purpose processor 206, a memory interface circuit 220 (“North Bridge”), and an I/O interface circuit 222 (“South Bridge”). Processor 206, memory 208 and GPUs 214 may be in communication with memory interface circuit 220. A speaker 216 may be interconnected to an audio output of processing engine 204 using an audio processor 224. After encoded audio from a Blu-ray disc (BD) in optical drive 202 is decompressed by processing engine 204, decoded audio data is received by speaker 216.

Device 200 may be a personal computer (PC), or a laptop computer, or a dedicated Blu-ray player. GPU 214A may be part of an integrated graphics processor (IGP) formed as an integrated circuit on a motherboard of device 200, while GPU 214B may be part of a PCI Express (PCIe) graphics card.

GPU 214B may have replaced own local video memory 226. Alternately, a portion of memory 208 may be used by one or both of GPUs 214A, 214B. Memory 208 may be part of the system memory for device 200 and thus may be used by processor 206 as well. Data stored in local memory 226, or in portions of memory 208 accessible by GPUs 214A, 214B may include commands, textures, off-screen buffers, and other temporary data generated for rendering. Of course, software, in the form of processor executable instructions for processor 206 and/or GPUs 214A, 214B to decode and display compressed video, may also be loaded into memory 208 prior to execution.

In operation, software executing on processor 206, in conjunction with one or more graphics processing units may be used to decode and display video from compressed multi-stream data. Compressed video streams may be stored on an optical disc such as BD, and may be read by optical drive 202.

As noted above, compressed video data from each stream corresponding to an image layer in a BD, as well as compressed audio data from one or more sources may be received as packetized elementary streams, that are then multiplexed together; for example in the form of MPEG-2 Transport Stream or similar (e.g., VC-1, H.264) stream.

In one embodiment, processor 206 may be used to de-multiplex the received transport stream (e.g., MPEG-2 Transport Stream), into packets of primary or secondary video and/or presentation or interactive graphics streams, each corresponding an image layer (sometimes called a plane). One of the GPUs (e.g., GPU 214B) may subsequently decode the packet contents to form video frames and graphics overlay images, while a second GPU (e.g. GPU 214A) may be used to composite the decoded images to form a multi-layer display image.

When de-multiplexing, processor 206 may store individual video or graphics streams corresponding to each of the image layers in separate stream buffers in memory 208 for example. An application software (such as PowerDVD) or a device driver for the GPUs may then direct GPU 214B, and GPU 214A to read stored streams from the stream buffers and decode the corresponding video frames or images.

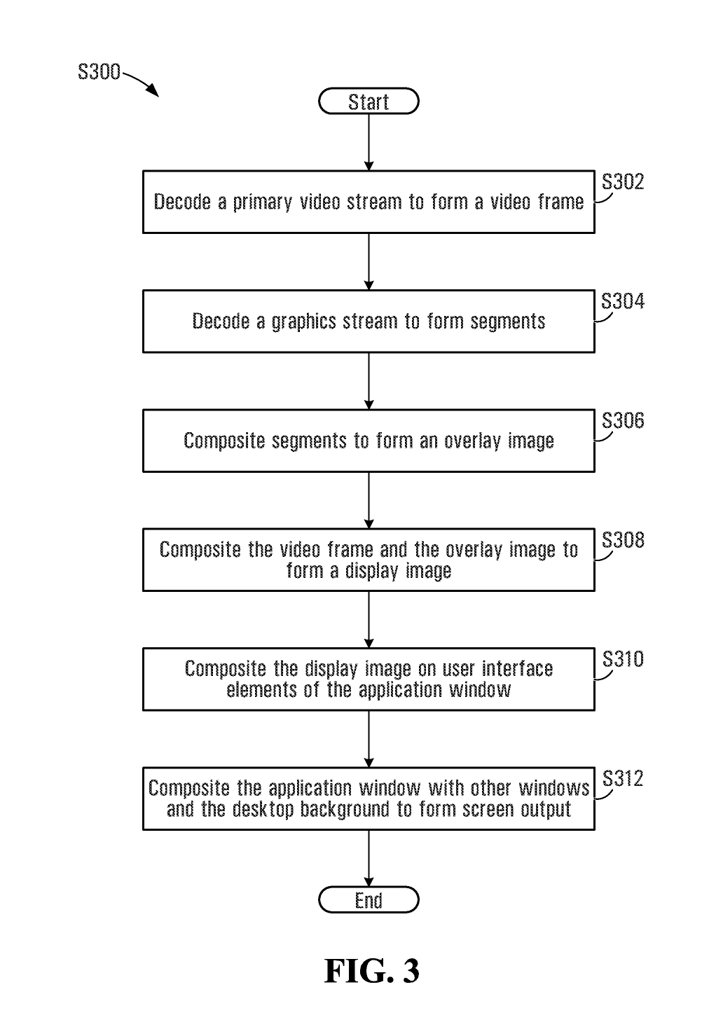

FIG. 3 depicts a flowchart S300 illustrating several major steps involved in presenting a multi-layered image constructed from multiple streams (e.g., from a BD) using exemplary device 200 in the form of a computing device. As will be detailed below, several compositing steps may be involved in presenting images from a Blu-ray disc to an interconnected display terminal.

In addition to decoding the primary (and secondary) video frames (S302), graphics or overlay images (i.e., presentation and/or interactive images) need to be composited from the graphics streams. The graphics streams in Blu-ray include syntactical elements called segments such as a Graphics Object Segment, Composition Segment and Palette Segment. A Composition Segment defines the appearance of a graphics display; a Graphics Object Segment represents run-length compressed bitmap data and a Palette Segment contains color and transparency data for translating color indexes (which may be 8-bits) to full color values.

Device 200 is may thus decode a graphics stream (presentation or interactive) to provide the segments required to construct or composite the overlay image (S304). The first composition step may thus involve construction of the graphics image using the decoded segments (S306).

Once the graphics images are formed (S306), then corresponding video frames (primary or, both primary and secondary) and graphics images (presentation and/or interactive) may be composited in a second composition step (S308) to form a display image for display. The display image may incorporate all available information provided in the Blu-ray disc.

If device 200 is a computing device, the composited final Blu-ray image is typically displayed within an application window (such as the PowerDVD application). Accordingly, a third composition step (S310) may be performed to position the image within the user interface elements of the application window. Finally, a fourth composition step (S312) may be used to display the application window (including its user interface elements and the Blu-ray display image), along with other application windows and desktop background of a computing device.

In one embodiment GPU 214B may read and decode all of the video and graphics streams, while GPU 214A composites corresponding decoded images to form a final image for display onto interconnected display 218.

In another embodiment, GPU 214B may composite segments from the graphics streams to form graphics images, decode primary (and secondary) video frames, form the Blu-ray image and composite the Blu-ray image with the application user interface. On the other hand GPU 214A may composite the image formed by GPU 214B (i.e., the Blu-ray image within the user interface elements of the player application such as PowerDVD) with other application unrelated windows and desktop background image, to form the screen output on display 218.

As will be appreciated, the division of concurrent computational tasks within processing engine 204 should correspond with the relative capabilities of GPUs 214A, 214B—that is, the more demanding of the concurrent tasks should normally be assigned to the more powerful GPU. For example, the graphics driver software may direct the more powerful GPU (e.g., GPU 214B) to decode and process the primary video stream while using the less powerful GPU (e.g., GPU 214A) to decode and process the secondary video, from a BD.

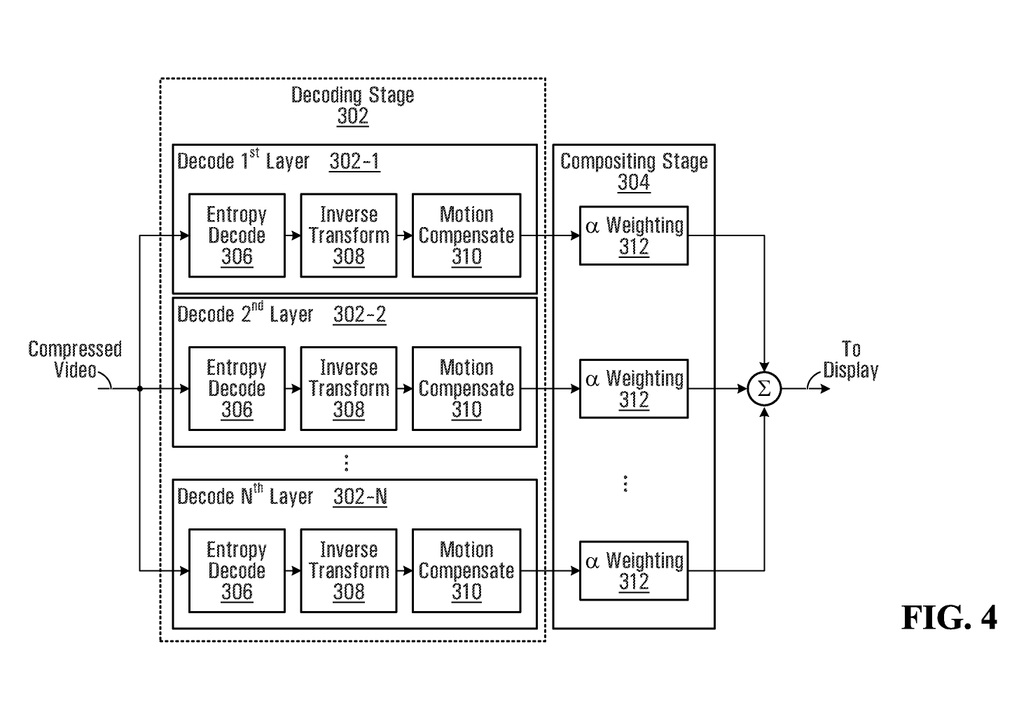

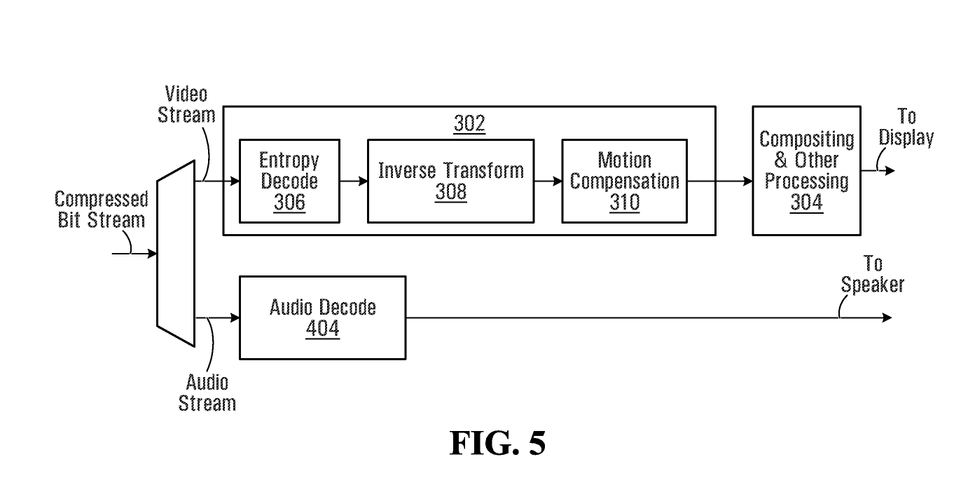

FIGS. 4 and 5 show simplified logical diagrams of the decoding and compositing stages performed by device 200. As depicted in FIG. 5, two major stages are identified as decoding stage 302 and compositing stage 304. Decoding stage 302 may be performed using software executing on processor 206, and hardware acceleration provided by GPU 214A, GPU 214B, or both. As well, de-multiplexed audio may be decoded by audio decoder 404.

For example, a compressed bit stream, in the form of a transport stream, may be received as an input by device 200. Each of the N streams corresponding to a graphics layer in the received transport stream may be de-multiplexed into N packetized elementary streams (PES) and subsequently decoded by GPU 214B in decoding stages 302-1, 302-2, . . . , 302-N corresponding to the first, second, . . . , N^{th} graphics layers of video. As may be appreciated, decoding of each stream may involve several operations including an entropy decoding stage 306, an inverse transform stage 308 and a motion compensation stage 310. In addition to the N video streams, one or more audio streams (not shown) from the transport stream may also be de-multiplexed and decoded as needed.

As noted above, decoding, compositing and displaying may be accomplished using GPUs 214A, 214B with software executing on processor 206 coordinating the process. Notably, device 200 may be a Blu-ray player capable of decoding a Blu-ray disc (BD) placed in optical drive 202 and processor 206 may download software that can be used to provide multi-stream video, animations, picture-in-picture and audio mixing from the BD. The downloaded software may, for example, be written in the Java™ programming language specified for the Blu-ray disc, called Blu-ray Disc Java (BD-J), and provided as Java archive (JAR) files. These JAR files maybe downloaded from a Blu-ray disc in drive 202, onto memory 208 or some other cache memory, by processor 206 and executed in a Java Virtual Machine (JVM) also running in processing engine 204 to provide interactivity, subtitles, secondary video, animation and the like. These features are provided as image layers to be composited together for display and may include an interactivity graphics layer, subtitle graphics layer, secondary video layer, primary video layer and the background layer. Each image corresponding to an image layer may be independent of all other layers and may have a full HDTV resolution.

Device 200 may also connect to a network such as the Internet through a peripheral network interface card (not shown) in electrical communication with I/O interface circuit 222. If network connection is available to device 200, dynamic content updates may be performed by the BD-J software to download new trailers for movies on a BD, to get additional subtitle options, to download add-on bonus materials and the like. Processor 206 may coordinate these tasks to be shared by GPUs 214A, 214B in parallel. For example, processor 206 may execute BD-J applications (called applets or xlets) to download games and trailers and utilize GPU 214A to provide the resulting animation, or display downloaded trailers, while GPU 214B may be used to provide hardware acceleration for decoding and displaying the main video layer from a BD in drive 202.

Decoded frames from each stream corresponding to an image layer may be composited or alpha-blended in compositing stage 304. As depicted, compositing stage 304 involves α-weighting stages 312 in which individual color components of decoded frame pixels from several layers are linearly combined as will be detailed below.

Alternately, instead of alpha-blending, keying may be used. Keying, sometimes called color keying or chroma keying, involves identifying a single preselected color or a relatively narrow range of colors (usually blue or green) and replacing portions of an image that match the preselected color by corresponding pixels of an alternate image or video frame. In background keying, pixels of the background image are replaced, while in foreground keying, pixels of a foreground object are keyed and subsequently replaced.

As may be appreciated, entropy decoding stage 306, inverse transform stage 308 and motion compensation stage 310 may be computationally intensive. Inverse transform stage 308 typically involves a standard inverse transform operation to be performed on square blocks of entropy decoded values obtained from MPEG-2 and/or H.264 encoded video sequences. This may be a very demanding operation and may thus be performed using the more powerful GPU (e.g. GPU 214B).

Decoded frames from each of the video and/or graphics streams corresponding to separate image layers, may be composited in compositing stage 304 by GPU 214A. As noted above, compositing refers to the combining of digital images (video frames or graphics images) from multiple image layers, to form a final image for presentation. To compose the final image, a color component of a foreground pixel F at location (x, y) of the foreground image is linearly combined with a corresponding color component of a background pixel B at the same location (x, y), using an opacity value (or equivalently transparency value) for pixel F—called the alpha channel or alpha value (denoted α_{F})—to form the combined final pixel C (x, y). Pixel B may be stored or otherwise represented as (r_{B}, g_{B}, b_{B}, α_{B}) in which r_{b}, g_{B}, b_{B} and α_{B} represent the red, green, blue and opacity values respectively. Alpha values used in computations may range from 0 (denoting complete transparency) to 1 (denoting full opacity). A background image is typically fully opaque and thus α_{B} may be set to 1 or omitted. Typically, in picture-in-picture applications, alpha values are not used. Instead a composition window is defined to display secondary video within the primary video.

Foreground pixel F at location (x, y) is also stored as (r_{F}, g_{F}, b_{F} α_{F}) where r_{F}, g_{F}, b_{F}, α_{F} represent the red, green, blue and opacity values respectively. Thus, for final pixel C at (x, y) the red green and blue color components (r_{c}, g_{c}, b_{c}) are computed as

r_{c}=(α_{F})r_{F}+(1−α_{F})r_{B}

g_{c}=(α_{F})g_{F}+(1−α_{F})g_{B}

b_{c}=(α_{F})b_{F}+(1−α_{F})b_{B}

Hence, while GPU 214B may be used to perform decoding stage 302; GPU 214A may be used to perform alpha-blending in accordance with the equations above—in α-weighting stages 312—and sum the resulting α-weighted values in compositing stage 304. The composited final image is then displayed on the interconnected display device.

The blending operation depicted, may also be performed in other color spaces such as the YCbCr color space. If source images to be composited are in different color spaces, then at least one image should be converted into another color space so that both source images are in the same color space.

GPU 214B, may reside on a PCIe card with a dedicated compositing engine, such as, for example, a Radeon graphics card supplied by AMD. Memory 208 may be loaded with an appropriate device driver for the graphics card hosting GPU 214B.

In variations of the above embodiment, GPU 214A and GPU 214B may be formed differently. For example, GPUs 214A, 214B may each reside on a separate PCIe card. Alternately, GPUs 214A, 214B can reside on the same PCIe card. As can be appreciated numerous alternative physical embodiments of GPUs 214A, 214B are possible. In addition, GPUs 214A, 214B may have same architecture and capabilities; or may have different architectures and different capabilities.

In alternate method of operation of device 200, GPU 214B may decode a first set of image layers—for example in Blu-ray, the background, primary video and secondary video—while GPU 214B decodes a second set of image layers (e.g., the presentation graphics for subtitles and the interactive graphics stream for menus). Interestingly, if GPU 214A forms part of an IGP, then GPU 214B, which may form part of a PCIe graphics card, need not be powerful enough to decode all of the image layers in Blu-ray (i.e., the primary and secondary video, background and the graphics streams) by itself. The requisite computational load of decoding and displaying video is shared between the two GPUs 214A, 214B. Thus, unlike the case in conventional device 100 (i.e., IGP 124), any existing IGP in device 200 (incorporating GPU 214A) can be fully utilized, together with GPU 214B to decode and display video.

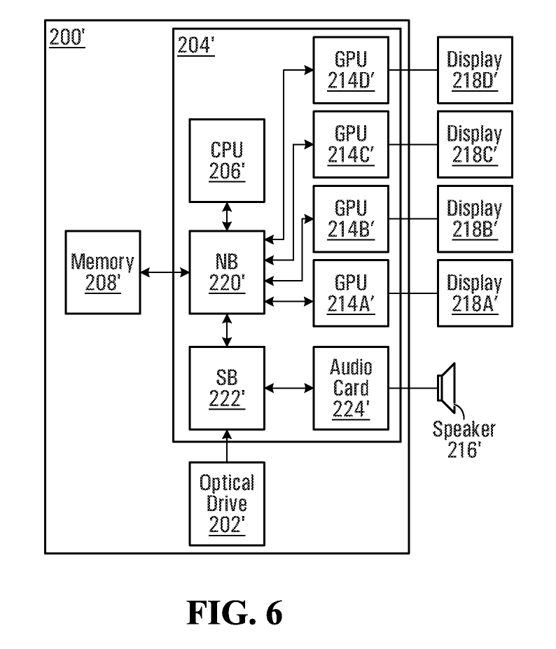

Yet another embodiment of the present invention is depicted schematically in FIG. 6. The device depicted in FIG. 6 may be substantially similar to device 200 depicted in FIG. 2 except for its interconnection to multiple displays and the presence of additional GPUs inside the processing engine. Like parts are similarly numbered, but suffixed with a prime (′) in FIG. 6 for to distinguish them from their counterparts in FIG. 2.

In FIG. 6, a video player device 200′ includes an optical drive 202′, a processing engine 204′ and a block of memory 208′. A bus such as the SATA bus may interconnect optical drive 202′ and processing engine 204′. Processing engine 204′ may contain multiple graphics processing units (GPUs) 214A′, 214B′, 214C′, 214D′ (individually and collectively GPUs 214′), a general purpose processor 206′, an audio processor 224′, a memory interface circuit 220′ (“North Bridge”), and an I/O interface circuit 222′ (“South Bridge”). A speaker 216′ is interconnected to an audio output of processing engine 204′. Decoded audio data is received by speaker 216′, using an audio processor 224′. Device 200′ may be interconnected to each of multiple displays 218A′, 218B′, 218C′, 218D′ (individually and collectively displays 218′) through individual display output interfaces corresponding to each GPU 214A′, 214B′, 214C′, 214D′.

In the embodiments noted above, compressed audiovisual data need not necessarily come from an optical drive. Any suitable medium such as a hard disk containing the compressed audiovisual data may be used to provide input to the input interface of the processing engine 204 (or 204′).

Advantageously, exploiting the organization of digital video data (e.g., on a Blu-ray disc), through the use of multiple GPUs in parallel allows cost reduction and power conservation. As even idle (i.e., not actively switching) circuitry that is supplied with power (such as an unused IGP 124), may nonetheless consume appreciable amounts of static power, the utilization of an otherwise idle (in conventional decoders) GPU to decode video and audio helps reduce overall power consumption in a video decoder/player.

In addition, for computers that already have an IGP, a graphics card with a less capable, inexpensive but power-efficient GPU may be used in lieu of a powerful but expensive and power-hungry GPU, to decode multi-stream high definition content, by concurrently utilizing of both the efficient GPU and the IGP in accordance with embodiments described herein. As powerful graphics card with power-hungry GPUs would be avoided, the overall cost of video decoder devices may be reduced accordingly.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A method of operating a video device comprising an input for receiving a plurality of compressed streams corresponding to different image layers, a processing engine comprising a first graphics processing unit (GPU), a second GPU, memory interconnected to at least one of said first GPU and second GPU and a display output interface, said method comprising:
(i) reading and decoding said plurality of compressed streams via said input using said first GPU to form a plurality of source images to be composited;
(ii) compositing in said memory, corresponding ones of said source images using said second GPU, to form display images; and
(iii) outputting said display images by way of said display output interface.

2. The method of claim 1, wherein said source images comprise video frames and overlay images and wherein said decoding said plurality of compressed streams comprises:
(i) decoding a first one of said plurality of streams to form said video frames; and
(ii) decoding a second one of said plurality of streams to from graphics segments, and compositing said segments to form said overlay images corresponding to said video frames.

3. The method of claim 2, wherein said compressed plurality of streams are stored on an optical disc.

4. The method of claim 3, wherein said optical disc is a Blu-ray disc.

5. The method of claim 4, wherein said first one of said plurality of streams is the primary video stream and said second one of said plurality of streams is one of a presentation graphics stream and an interactive graphics stream.

6. The method of claim 1, wherein compositing said corresponding ones of said source images comprises one of: alpha-blending and keying.

7. The method of claim 1, further comprising displaying said display images on a display interconnected to said display output interface.

8. A method of operating a video device, said device comprising: an input for receiving a plurality of compressed video streams corresponding to different image layers, a processing engine comprising: a first graphics processing unit (GPU), a second GPU, memory and a display output interface each interconnected to at least one of said first GPU and second GPU, said method comprising:
(i) reading and decoding said plurality of compressed video streams via said input to form a plurality of source images to be composited, using said first GPU;
(ii) compositing in said memory, corresponding ones of said source images to form a display image, using said first GPU; and
(iii) outputting said display images to an interconnected display through said display output interface, using said second GPU.

9. A method of operating a computing device comprising: an input for receiving a plurality of compressed video streams corresponding to different image layers, a processing engine comprising: a first graphics processing unit (GPU), a second GPU, a processor, memory and a display output interface each interconnected to at least one of said first and second GPUs, said method comprising:
(i) reading and decoding a first one of said plurality of streams to form a plurality of video frames, using said first GPU;
(ii) reading and decoding a second one of said plurality of streams to form graphics segments, using said first GPU;
(iii) compositing said graphics segments to form a plurality of overlay images, using said first GPU;
(iv)compositing in said memory, corresponding ones of said video frames and said overlay images using said first GPU, to form a plurality of display images;
(v) compositing said display images with user interface elements of a video application to form a video application window for display using one of said first and second GPUs; and
(vi)compositing said video application window with other application windows and a background desktop image, to form an output screen for display on a display interconnected to said display interface.

10. The method of claim 9, wherein compositing said video frames and said overlay images comprises alpha-blending or keying.

11. The method of claim 9, further comprising outputting said output screen to on said display through said output interface using said second GPU.

12. The method of claim 9, wherein said first GPU is used for said compositing said display images with user interface elements.

13. The method of claim 9, wherein said second GPU is used for said compositing said display images with user interface elements.

14. A digital video player device comprising:
(i) an input for receiving a plurality of streams, each corresponding to one of a plurality of image layers;
(ii) a graphics processing engine comprising a first graphics processing unit (GPU) and a second GPU;
(iii) memory in communication with said first and second GPUs; and
(iv)a display output interface;
said input receiving said streams; said graphics processing engine processing said streams to from images corresponding to said plurality of image layers using said first GPU and compositing in said memory, corresponding ones of said images from display images, said second GPU outputting said display images to an interconnected display through said display output interface.

15. The device of claim 14, further comprising an optical drive in communication with said input.

16. The device of claim 15, wherein said plurality of streams are Blu-ray compliant.

17. The device of claim 14, wherein said digital video player device comprises a computing device.

18. The device of claim 17, wherein said computing device is a laptop computer.

19. The device of claim 17, wherein said first GPU is formed on a peripheral expansion card.

20. The device of claim 19, wherein said second GPU comprises an integrated graphics processor (IGP).
